(19) United States
(12) Patent Application Publication
(10) Pub. No.: US 2016/0226052 A1
(43) Pub. Date: Aug. 4, 2016

(54) SECONDARY BATTERY

(71) Applicant: Samsung SDI Co., Ltd., Yongin-si (KR)

(72) Inventors: Mansik Cho, Yongin-si (KR); Sunhye Hu, Yongin-si (KR); Moonsan Ahn, Yongin-si (KR)

(21) Appl. No.: 14/924,116

(22) Filed: Oct. 27, 2015

(30) Foreign Application Priority Data
Jan. 30, 2015 (KR) 10-2015-0015592

(51) Int. Cl. H01M 2/20; H01M 2/30; H01M 10/42; H01M 2/10

(52) U.S. Cl. CPC H01M 2/204; H01M 2/105; H01M 2/1077; H01M 2/206; H01M 2/305; H01M 2/30; H01M 10/4257; H01M 2220/10; H01M 2220/20; H01M 2220/30

(57) ABSTRACT

A secondary battery is disclosed. In one aspect, the battery includes a plurality of battery cells and a protective circuit module placed at a first side of the battery cells and configured to control a charging/discharging operation. The battery also includes a connection tab electrically connecting the battery cells and the protective circuit module and an external terminal in electrical connection with the protective circuit module. The connection tab and the external terminal extend substantially parallel to each other along a longitudinal direction of the secondary battery and are placed at different levels in a first direction different from the longitudinal direction.

### INCORPORATION BY REFERENCE TO ANY PRIORITY APPLICATIONS

This application claims the benefit of Korean Patent Application No. 10-2015-0015592, filed on Jan. 30, 2015, in the Korean Intellectual Property Office, the disclosure of which is incorporated herein in its entirety by reference.

### BACKGROUND

1. Field

The described technology generally relates to secondary batteries.

2. Description of the Related Technology

Unlike primary batteries, secondary batteries are rechargeable. They are used as energy sources for mobile devices, electric vehicles, hybrid vehicles, and electric bicycles, or as uninterruptible power supplies. According to the types of devices that operate based on such batteries, the secondary batteries may be used in the form of one battery or a pack including a plurality of batteries electrically connected to one another to form one unit.

### SUMMARY OF CERTAIN INVENTIVE ASPECTS

One inventive aspect relates to secondary batteries that are used to provide power of set devices and are advantageous to make the entire device together with the set devices compact.

Another aspect is a secondary battery that includes: at least two or more battery cells; a protective circuit module placed at a rear position of the battery cells and configured to control a charging/discharging operation; a connection tab configured to form a current path between the at least two or more battery cells and the protective circuit module; and an external terminal configured to form a current path between the protective circuit module and an external device, wherein the connection tab and the external terminal may extend in parallel to each other along a longitudinal direction of the secondary battery and may be placed at different levels in a first direction different from the longitudinal direction.

The protective circuit module may be placed in an upright position in the first direction so that front and rear surfaces thereof form a main surface.

The connection tab and the external terminal may be placed in front of the protective circuit module.

A height H1 of the battery cells in the first direction may be less than a height H2 of the protective circuit module in the first direction satisfies (H1<H2).

A length L1 of battery cells in the longitudinal direction may be greater than a length L2 of the protective circuit module in the longitudinal direction (L1>L2).

The at least two or more battery cells may be arranged in a curved direction along a circular arc shape.

The secondary battery may further include a cell holder into which the battery cells are inserted so as to connect the plurality of battery cells and to define an assembling position of the battery cells.

The cell holder may include a composite material.

The battery cells may be arranged in a first row and a second row at a rear position of the first row.

The battery cells in the first row and the battery cells in the second row may be arranged in the same curved direction.

The secondary battery may further include connection members configured to electrically connect the battery cells to one another.

The connection members may include: a first connection member configured to electrically connect the battery cells to each other in the same first row or in the same second row; and a second connection member configured to electrically connect the battery cells in the first row to the battery cells in the second row.

The second connection member may connect the battery cells in the first row to the battery cells in the second row.

The secondary battery may further include a case including a cell accommodation portion in which the battery cells are accommodated, and a circuit accommodation portion in which the protective circuit module is accommodated, and terminal holes for exposing the external terminal may be formed in the circuit accommodation portion that protrudes upward from the cell accommodation portion.

The case may include first and second cases assembled in the first direction so that the first and second cases face each other, and a step height caused by a difference in heights of the cell accommodation portion and the circuit accommodation portion may be formed in the first case in an upward position, and the cell accommodation portion and the circuit accommodation portion may be formed in the second case in a downward position and may have same height.

The terminal holes may include first and second terminal holes for exposing first and second external terminals having opposite polarities, respectively, and an inversed insertion prevention portion for preventing inversed insertion caused by polarity confusion may be formed in a vicinity of the first and second terminal holes.

The inversed insertion prevention portion may include protrusions formed asymmetrically in the vicinity of the first and second terminal holes.

Another aspect is a secondary battery comprising: a plurality of battery cells; a protective circuit module placed at a first side of the battery cells and configured to control a charging/discharging operation; a connection tab electrically connecting the battery cells and the protective circuit module; and an external terminal in electrical connection with the protective circuit module, wherein the connection tab and the external terminal extend in substantially parallel to each other along a longitudinal direction of the secondary battery and are placed at different levels in a first direction different from the longitudinal direction.

In the above battery, the protective circuit module is placed in an upright position in the first direction so that front and rear surfaces thereof form a main surface. In the above battery, the connection tab and the external terminal are placed in a first surface of the protective circuit module, wherein the first surface faces the batteries. In the above battery, the height H1 of the battery cells defined in the first direction is less than the height H2 of the protective circuit module defined in the first direction satisfies (H1<H2). In the above battery, the length L1 of the battery cells defined in the longitudinal direction is greater than the length L2 of the protective circuit module defined in the longitudinal direction (L1>L2). In the above battery, the battery cells are arranged in a curved direction. The above battery further comprises a cell holder into which the battery cells are inserted so as to connect the battery cells and to define an assembling position of the battery cells.

In the above battery, the cell holder is formed of a composite material. In the above battery, the battery cells are arranged in a first row and a second row adjacent to each other. In the above battery, the battery cells in the first row and the battery cells in the second row are arranged in the same curved direction. The above battery further comprises a plurality of connection members configured to electrically connect the battery cells to one another. In the above battery, the connection members comprise: a first connection member configured to electrically connect the battery cells to each other in the same first row or in the same second row; and a second connection member configured to electrically connect the battery cells in the first row to the battery cells in the second row. In the above battery, the second connection member connects the battery cells in the first row to the battery cells in the second row.

The above battery further comprises a case comprising a cell accommodation portion in which the battery cells are accommodated, and a circuit accommodation portion in which the protective circuit module is accommodated, and wherein at least one terminal hole configured to expose the external terminal is formed in the circuit accommodation portion that protrudes upwardly from the cell accommodation portion. In the above battery, the case comprises first and second cases assembled in the first direction so that the first and second cases face each other, wherein a step height caused by a difference in heights of the cell accommodation portion and the circuit accommodation portion is formed in the first case in an upward position, and wherein the cell accommodation portion and the circuit accommodation portion are formed in the second case in a downward position and have substantially the same height.

In the above battery, the terminal holes comprise first and second terminal holes respectively configured to expose first and second external terminals having opposite polarities, respectively, and wherein an inversed insertion prevention portion configured to prevent inversed insertion caused by polarity confusion is formed in a vicinity of the first and second terminal holes. In the above battery, the inversed insertion prevention portion comprises a plurality of protrusions formed asymmetrically adjacent to the first and second terminal holes.

Another aspect is a secondary battery comprising: a first cell holder configured to accommodate a first group of battery cells, wherein the first cell holder is curved to have a first curvature; and a second cell holder adjacent to the first cell holder and configured to accommodate a second group of battery cells electrically connected to the first group of battery cells, wherein the second cell holder is curved to have a second curvature substantially the same as the first curvature, and wherein the first and second cell holders are arranged to accommodate the first and second groups of battery cells to be substantially aligned in a longitudinal direction thereof.

The above battery further comprises: a protective circuit module placed at a side of the first or second group of battery cells and configured to control a charging/discharging operation; a connection tab electrically connecting the battery cells and the protective circuit module; and an external terminal in electrical connection with the protective circuit module, wherein the connection tab and the external terminal are placed on the same side of the protective circuit module. In the above battery, each of the first and second groups of battery cells are arranged in a curved direction.

### BRIEF DESCRIPTION OF THE DRAWINGS

These and/or other aspects will become apparent and more readily appreciated from the following description of the exemplary embodiments, taken in conjunction with the accompanying drawings.

FIG. 1 is a perspective view of a secondary battery according to an exemplary embodiment.

FIG. 2 is an exploded perspective view of the secondary battery illustrated in FIG. 1.

FIG. 3 is an exploded perspective view of the secondary battery illustrated in FIG. 2 in an electrical connection state.

FIG. 4 is a perspective view of a protective circuit module of the secondary battery of FIG. 2.

FIG. 5 is a view of a case of the secondary battery of FIG. 1.

FIG. 6 is a view showing terminal holes formed in the case of FIG. 5.

### DETAILED DESCRIPTION OF CERTAIN INVENTIVE EMBODIMENTS

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present description. In this disclosure, the term “substantially” includes the meanings of completely, almost completely or to any significant degree under some applications and in accordance with those skilled in the art. Moreover, “formed on” can also mean “formed over.” The term “connected” includes an electrical connection.

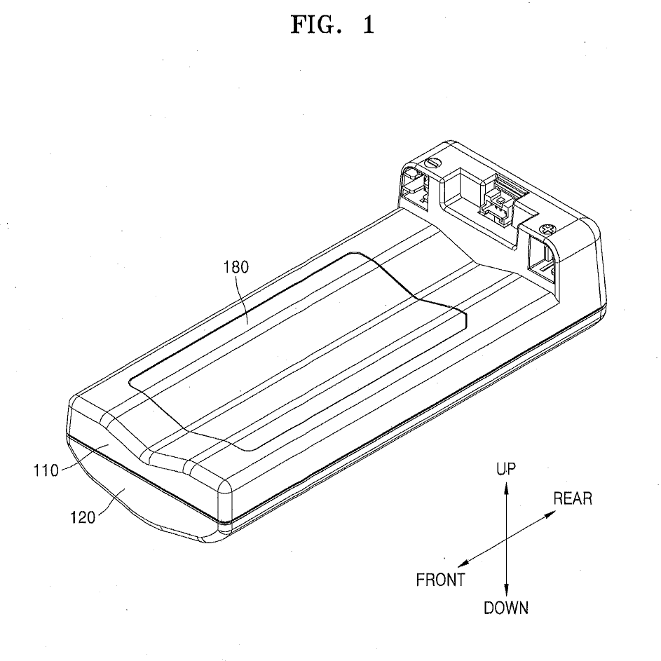

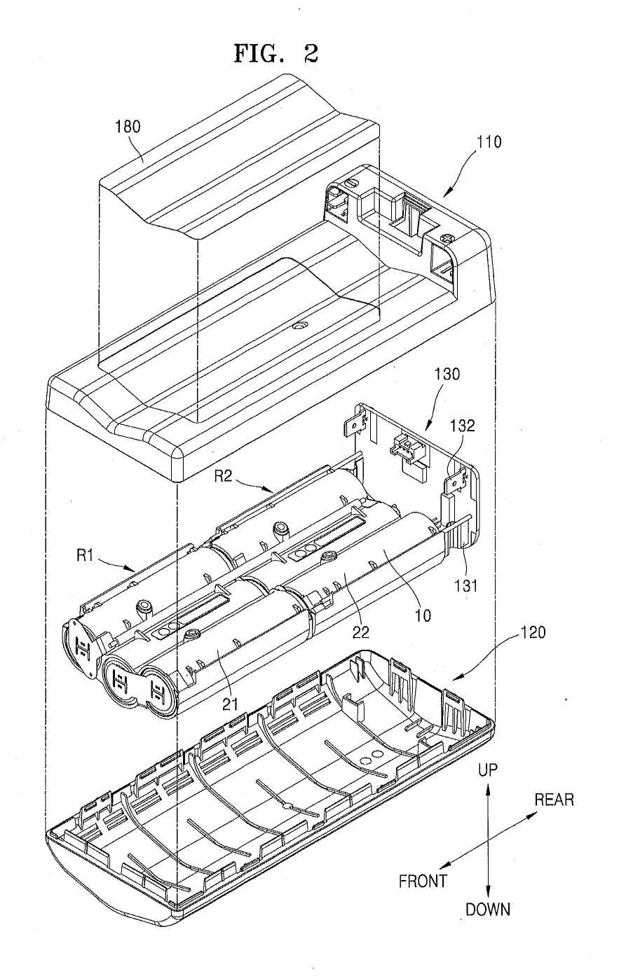

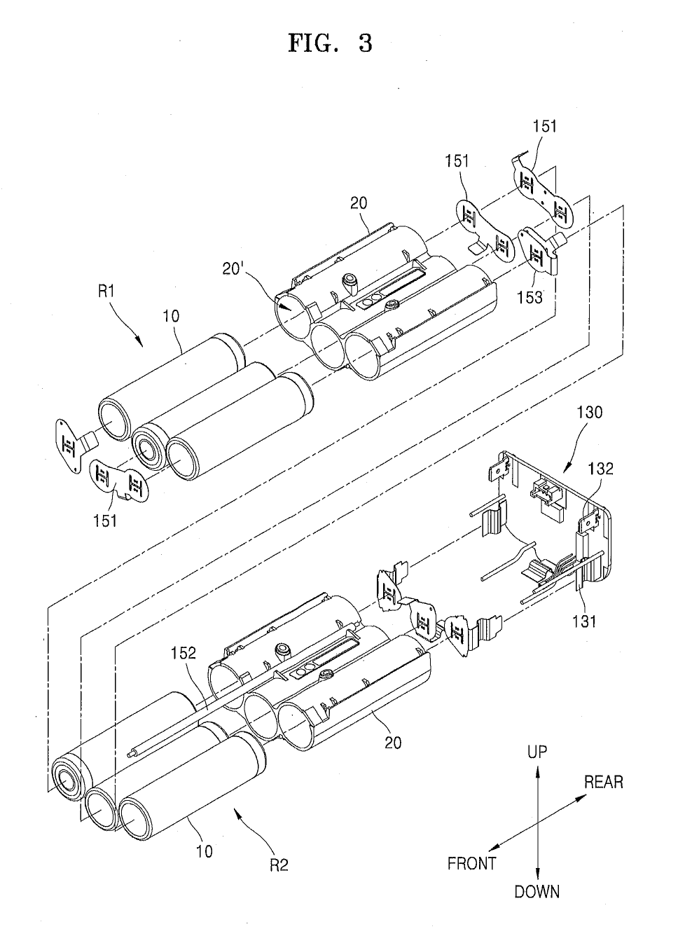

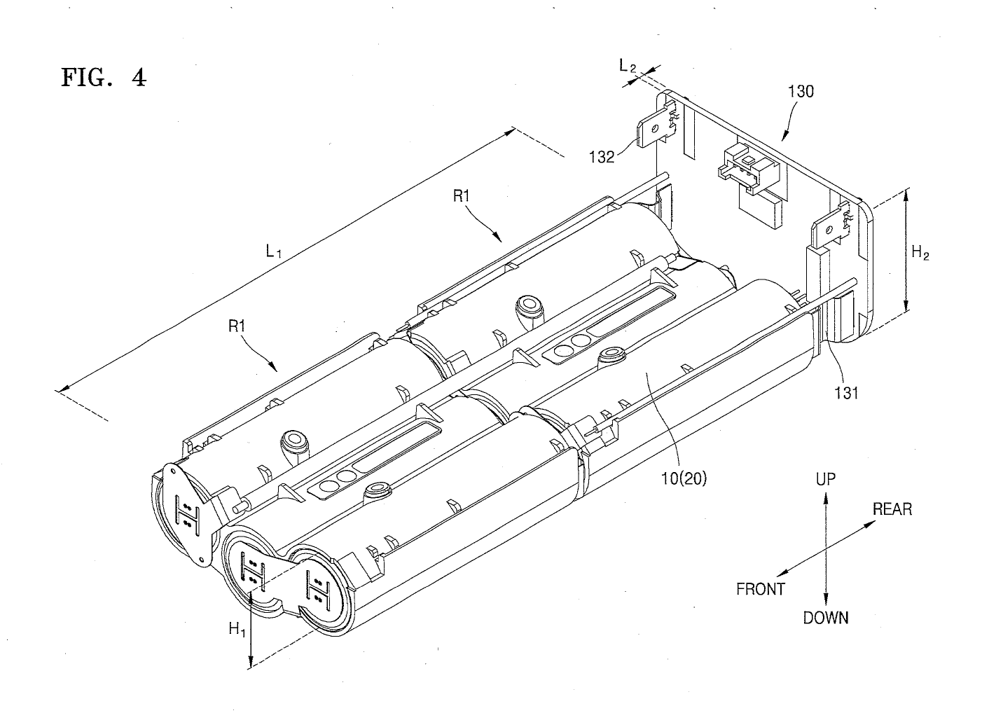

FIG. 1 is a perspective view of a secondary battery according to an exemplary embodiment. FIG. 2 is an exploded perspective view of the secondary battery illustrated in FIG. 1. FIG. 3 is an exploded perspective view of the secondary battery illustrated in FIG. 2 in an electrical connection state. FIG. 4 is a perspective view of a protective circuit module of the secondary battery of FIG. 2.

Referring to FIG. 2, the secondary battery includes a plurality of battery cells 10, a protective circuit module 130 that is placed at a rear position of the battery cells 10 and controls a charging/discharging operation of the battery cells 10, a connection tab 131 that intermediates electrical connection between the battery cells 10 and the protective circuit module 130, and an external terminal 132 that intermediates electrical connection between the protective circuit module 130 and an external device (not shown). For example, the connection tab 131 forms a path of a charging/discharging current between the battery cells 10 and the protective circuit module 130, and the external terminal 132 forms a path of a charging/discharging current between the protective circuit module 130 and the external device (not shown). The connection tab 131 and the external terminal 132 extend in substantially parallel to each other along a longitudinal direction of the secondary battery (e.g., forward/backward direction) and are placed at different levels in a substantially vertical direction (which corresponds to a first direction, hereinafter, the same as above).

The battery cells 10 may be electrically connected to each other, and may provide necessary electrical outputs. For example, the battery cells 10 may be connected to each other in series or in parallel or may be connected to each other in a serial/parallel mixed manner. In some embodiments, the secondary battery includes six battery cells 10. These six battery cells 10 may be connected to each other in series and may provide necessary outputs with high voltages.

For example, the battery cells 10 may be arranged in two rows along the longitudinal direction. For example, the battery cells 10 are arranged along a first row R1 and a second row R2 at a rear position of the first row R1, substantially parallel to the first row R1. For example, the longitudinal direction throughout the specification is a direction in which the battery cells 10 and the protective circuit module 130 are arranged. As will be described later, a charging/discharging operation of the battery cells 10 may be performed according to control of the protective circuit module 130 placed at a rear position of the battery cells 10.

The battery cells 10 and the protective circuit module 130 may be accommodated in first and second cases 110 and 120 that face and are coupled to each other in a substantially vertical direction. An insulating plate 180 may be placed on the first case 110 in an upward position. In this case, the insulating plate 180 may provide a contact surface with a set device (not shown) having a secondary battery used to provide driving power and may perform a function of insulation and protection from the set device.

As illustrated in FIG. 3; the battery cells 10 may be electrically connected to each other via connection members 151, 152, and 153. The connection members 151, 152, and 153 may include first and second connection members 151 and 152 having different shapes. For example, the first connection member 151 may electrically connect the battery cells 10 to each other in the same first row R1 or in the same second row R2. The first connection member 151 may have a plate shape and can extend in a predetermined position in the forward/backward direction.

The first connection member 151 may be placed at at least two or more locations, for example, at three locations. The second connection member 152 may electrically connect the battery cells 10 in the first row R1 to the battery cells 10 in the second row R2. For example, the second connection member 152 connects electrodes of the battery cells 10 in the first row R1 to electrodes of the battery cells 10 in the second row R2. The battery cells 10 placed in the respective first and second rows R1 and R2 to be electrically connected may include a first pair of electrodes placed close to each other and a second pair of electrodes placed away from each other compared to the first pair of electrodes. In this case, the second connection member 152 may electrically connect the second pair of electrodes placed away from each other. The second connection member 152 may include a conductive member with a wire shape extended along the forward/backward direction. As will be described later, adjacent electrodes of the battery cells 10 in the first row R1 and the battery cells 10 in the second row R2 may be electrically connected to each other using the third connection member 153.

The first and second connection members 151 and 152 can have different shapes in terms of a connection length between the battery cells 10 and the protective circuit module 130. That is, the connection length may be shortened by placing the battery cells 10 to be connected to the protection circuit module 130 at a rear position where the battery cells 10 are placed to face the protection circuit module 130. Accordingly, in order to position the battery cells 10 of both ends with the highest and lowest potentials among the electrically connected battery cells 10 at the same rear portion, it may be necessary to have not only the first connection member 151 but also the second connection member 152 which connects the battery cells 10 placed in the different first and second rows R1 and R2.

The third connection member 153 can connect pairs of adjacent electrodes of the battery cells 10 in the first row R1 and the battery cells 10 in the second row R2 to each other. For example, the third connection member 153 may be provided as needed. The battery cells 10 in the first row R1 and the battery cells 10 in the second row R2 may contact each other so that the pairs of adjacent electrodes thereof may be connected to each other. In this case, the third connection member 153 may be omitted.

The protective circuit module 130 controls the charging/discharging operation of each of the battery cells 10. For example, the protective circuit module 130 collects status information, such as a voltage, a current, or a temperature of each of the battery cells 10 and controls the charging/discharging operation of each battery cell 10. For example, the protective circuit module 130 may detect an unusual situation, such as over-charging or over-discharging, and may perform a safety operation corresponding to the unusual situation.

Referring to FIG. 4, the protective circuit module 130 may extend in the vertical direction that is different from the forward/backward direction. The protective circuit module 130 may be placed in an upright position in the vertical direction. That is, the protective circuit module 130 may not be placed in a flat lying position along the forward/backward direction. The arrangement of the protective circuit module 130 may reduce the length of the secondary battery in the forward/backward direction and may contribute to making the entire device compact.

The protective circuit module 130 may include a circuit board and electric devices mounted on a circuit board. In this case, the circuit board may be placed in the upright position in the vertical direction so as to have a front surface and a rear surface as a main surface. Here, the main surface can be a surface having the largest area when the circuit board is viewed in the form of a plate. The protective circuit module 130 may be placed in the upright position in the vertical direction and may have the front and rear surfaces as the main surface.

Since the protective circuit module 130 is placed in the upright position in the vertical direction, the protective circuit module 130 has a relatively large dimension in the vertical direction. Contrary to this, the battery cells 10 are placed along the forward/backward direction, and the battery cells 10 in the first row R1 and the battery cells 10 in the second row R2 are arranged along the forward/backward direction, the battery cells 10 have a relatively large dimension in the forward/backward direction. Thus, the height H1 of the battery cells 10 (or the arrangement of battery cells) in the vertical direction is less than the height H2 of the protective circuit module 130 in the vertical direction (H1<H2). Also, the length L1 of the battery cells (or the arrangement of battery cells) in the longitudinal direction is greater than the length L2 of the protective circuit module 130 in the forward/backward direction (L1>L2).

The protective circuit module 130 is placed on an electrical path between the battery cells 10 and the external device (not shown), i.e., between a charging device and a load. That is, the protective circuit module 130 intermediates electrical connection between the battery cells 10 and the external device. In some embodiments, the connection tab 131 is interposed between the protective circuit module 130 and the battery cells 10. On the other hand, the external terminal 132 is interposed between the protective circuit module 130 and the external device. In this case, the connection tab 131 and the external terminal 132 extend to be substantially parallel to each other. For example, the connection tab 131 and the external terminal 132 extend to be substantially parallel to each other along the forward/backward direction. Furthermore, each of the connection tab 131 and the external terminal 132 may have a locally slightly-bent shape. However, overall, the connection tab 131 and the external terminal 132 may extend to be substantially parallel to each other along the forward/backward direction.

The secondary battery may be mounted on a set device (not shown), such as a cleaning device, and may provide driving power. In this case, the secondary battery may be implemented in a compact shape in a state in which it is coupled to the set device. The secondary battery is used while being coupled to the set device, and a design of the entire device coupled to the set device may affect consumers' preference. For this reason, the connection tab 131 and the external terminal 132 may be placed together on the same side of the protective circuit module 130, e.g., in front of the protective circuit module 130. For example, when the connection tab 131 and the external terminal 132 are placed on opposite sides of the protective circuit module 130, i.e., in front and rear of the protective circuit module 130 that are different from each other, the battery cells 10 connected to the connection tab 131 are placed in front of the protective circuit module 130, and the set device connected to the external terminal 132 is placed in rear of the protective circuit module 130 so that the configuration of the entire device extends long in the forward/backward direction and is not advantageous to making the entire device compact.

In an exemplary embodiment, all of the connection tab 131 and the external terminal 132 are placed in front of the protective circuit module 130 so that all of the battery cells connected to the connection tab 131 and the set device (not shown) connected to the external terminal 132 may be placed in front of the protective circuit module 130. Thus, the length of the entire device in the forward/backward direction may be reduced, and the configuration of the entire device may be advantageous to making the secondary battery compact.

All of the connection tab 131 and the external device 132 form connection with the protective circuit module 130 and are placed in front of the protective circuit module 130. Thus, the connection tab 131 and the external terminal 132 may be placed at different levels in the vertical direction so as to prevent confusion of the electrical path. Also, the external terminal 132 is placed in the upward position in which the battery cells 10 are excluded, and forms connection with the set device (not shown) in the position. That is, the external terminal 132 forms connection with the set device in the upward position of the protective circuit module 130, whereas the connection tab 131 forms connection with the battery cells 10 in a downward position of the protective circuit module 130. Thus, a dead space may be removed from a vertical position of the protective circuit module 130, and the secondary battery may form compact coupling to the set device (not shown).

The battery cells 10 may be arranged to be rounded. For example, the battery cells 10 may not extend in a straight line shape along a left/right direction but are arranged in a rounded, circular arc shape. In this embodiment, the battery cells 10 are arranged in a curved shape. The arrangement of the battery cells 10 in the curved shape may be expressed as an exterior of the secondary battery, may implement an ergonomically rounded shape, and may provide a more aesthetic design.

The battery cells 10 in the first row R1 may be arranged in the curved shape, and the battery cells 10 in the second row R2 may be arranged in the curved shape. The battery cells 10 in the first row R1 and the battery cells 10 in the second row R2 may be arranged in substantially the same curved shape.

The arrangement of the battery cells 10 in the curved shape may contribute to matching with the set device (not shown). For example, the secondary battery may be mounted on the set device, such as the cleaning device, and may supply driving power to the set device. The secondary battery in the curved shape that closely contacts a round shape of a periphery of a motor (not shown) of the cleaning device may be advantageous to making the entire device together with the set device compact, which provides a stable supporting base for the secondary battery through closely-contacting matching with the set device.

As illustrated in FIG. 3, the battery cells 10 may be electrically connected to each other using the connection members 151, 152, and 153 and may also be structurally connected to each other using a cell holder 20 into which the battery cells 10 are inserted. The cell holder 20 may implement the arrangement of the battery cells 10 in the first row R1 in a predetermined curved shape and may implement the arrangement of the battery cells 10 in the second row R2 in the same curved shape. For example, the cell holder 20 may include a first cell holder 21 into which the battery cells 10 in the first row R1 are inserted, and a second cell holder 22 into which the battery cells 10 in the second row R2 are inserted.

The cell holder 20 may connect the battery cells 10 structurally, may define an assembling position of the battery cells 10, and may promote heat-dissipation of the battery cells 10. The cell holder 20 may be formed of a material having an electrical insulation property and high thermally high conductivity. For example, the cell holder 20 may be formed of a composite material including a matrix resin that accommodates glass fiber or carbon fiber having excellent thermal conductivity.

The cell holder 20 may include an opening 20′ (see FIG. 3) having the shape of a cylinder that surrounds an outer circumference of each of the battery cells 10, may form thermal contact with the battery cells 10 inserted into the opening 20′, and may dissipate heat transferred from the battery cells 10 to the environment quickly. For example, the battery cells 10 in the first row R1 are assembled to the cell holder 20. Even when thermal accumulation occurs in part of the battery cells 10 due to a position effect or a difference in a manufacturing process, thermal concentration may be prevented and driving heat may be quickly propagated using the cell holder 20.

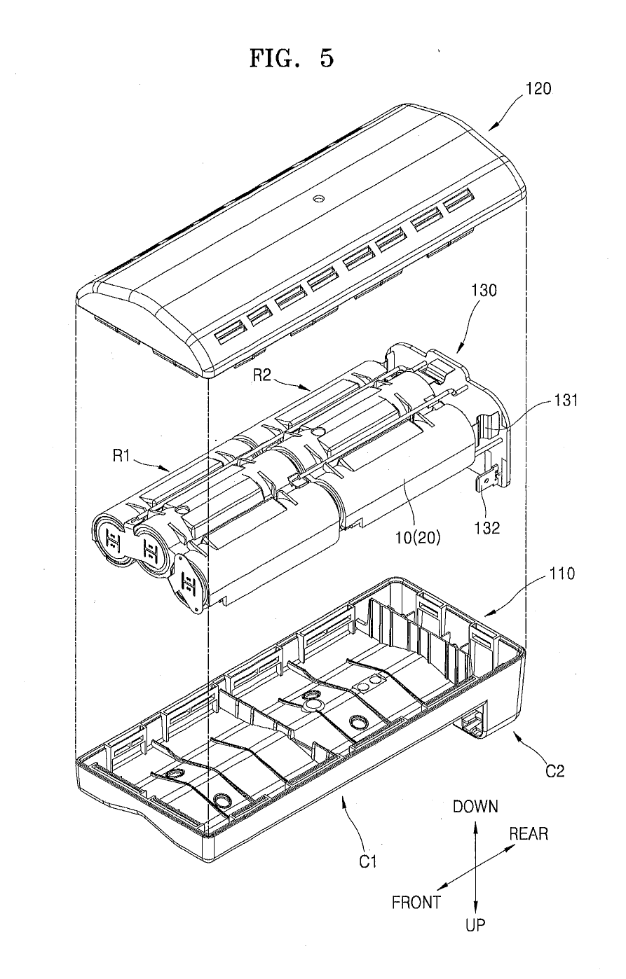

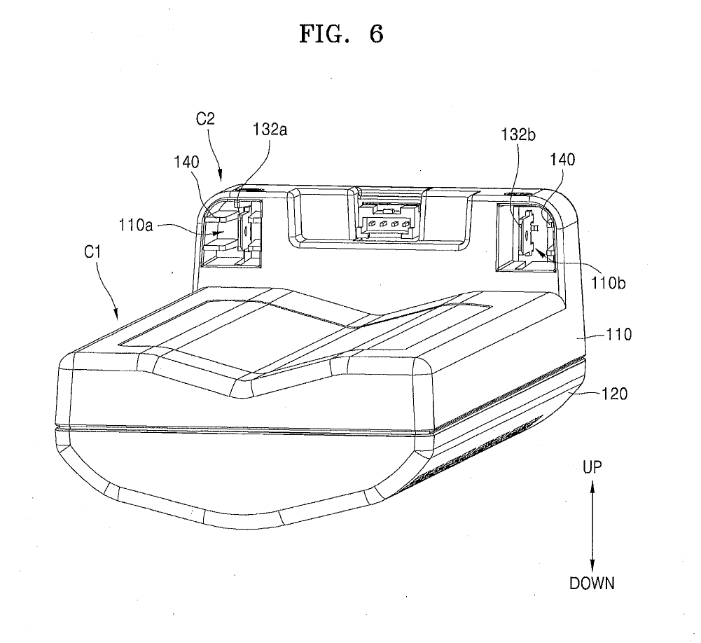

FIG. 5 is a view for describing a structure of cases 110 and 120 of the secondary battery of FIG. 1. FIG. 6 is a view for describing a structure of terminal holes 110a and 110b formed in the cases 110 and 120 of FIG. 5.

The battery cells 10 and the protective circuit module 130 are accommodated in the cases 110 and 120. The cases 110 and 120 may include first and second cases 110 and 120 assembled to face each other in a state in which the battery cells 10 and the protective circuit module 130 are interposed between the first and second cases 110 and 120. In some embodiments, the cases 110 and 120 include a cell accommodation portion C1 in which the battery cells 10 are accommodated, and a circuit accommodation portion C2 in which the protective circuit module 130 is accommodated. As described above, the battery cells 10 are placed in the first and second rows R1 and R2 along the forward/backward direction, and the protective circuit module 130 is placed in the upright position in the vertical direction. Thus, the cell accommodation portion C1 and the circuit accommodation portion C2 may be formed to have different heights along the vertical direction. The height of the circuit accommodation portion C2 may be greater than the height of the cell accommodation portion C1.

The first and second cases 110 and 120 can be assembled to face in the vertical direction. In this case, the height of the cell accommodation portion C1 and the height of the circuit accommodation portion C2 in the first case 110 placed in the upward direction may be set to be different from each other, and the height of the cell accommodation portion C1 and the height of the circuit accommodation portion C2 in the second case 120 placed in the downward direction may be set to be substantially the same. For example, a step height caused by a difference between the heights of the cell accommodation portion C1 and the circuit accommodation portion C2 is formed in the first case 110, wherein the cell accommodation portion C1 and the circuit accommodation portion C2 in the second case 120 may be formed at substantially the same level in a flat shape.

As the height of the cell accommodation portion C1 and the height of the circuit accommodation portion C2 are set to be different from each other, the circuit accommodation portion C2 has a step height that protrudes upward from the cell accommodation portion C1. As illustrated in FIG. 6, terminal holes 110a and 110b for exposing the external terminal 132 are formed in the circuit accommodation portion C2 that protrudes upward from the cell accommodation portion C1. The external terminal 132 exposed from the secondary battery through the terminal holes 110a and 110b is connected to the external device and forms a path of a charging/discharging current.

The terminal holes 110a and 110b can be formed as a pair to correspond to external terminals 132a and 132b having opposite-polarity electrodes, i.e., positive and negative electrodes. In this case, an inversed insertion prevention portion 140 for preventing inversed insertion of polarity confusion may be formed in the vicinity of the terminal holes 110a and 110b. The inversed insertion prevention portion 140 is formed in the vicinity of the terminal holes 110a and 110b, and protrusions may be asymmetrically formed in the vicinity of a positive electrode terminal hole 110a (first terminal hole) and the vicinity of a negative electrode terminal hole 110b (second terminal hole). For example, the secondary battery may be connected to a set device (not shown) and may provide driving power of the set device. In this case, in order to prevent inversed insertion into the set device, i.e., polarity confusion between the set device and the secondary battery, protrusions having an asymmetric shape are provided in the vicinity of the terminal holes 110a and 110b of the secondary battery, i.e., in the vicinity of the positive electrode and negative electrode terminal holes 110a and 110b so that inversed insertion caused by confusion of polarities may be fundamentally prevented. For example, when the secondary battery and the set device (not shown) are properly connected to each other, they may be smoothly connected to each other without disturbance of the inversed insertion prevention portion 140. However, when inversed insertion caused by confusion of polarities occurs, connection between the secondary battery and the set device is not allowed by disturbance of the inversed insertion prevention portion 140. Each of the terminal holes 110a and 110b can include a plurality of holes.

According to at least one of the disclosed embodiments, a secondary battery may be used to provide power of a set device. In this case, the secondary battery may provide a structure advantageous to making the entire device together with the set device compact. In an exemplary embodiment, battery cells and a protective circuit module for controlling a charging/discharging operation of the battery cells are placed in different directions, and a connection tab and an external terminal that intermediate electrical connection between the battery cells and the set device are placed on the same side of the protective circuit module so that the entire device may be made compact.

In addition, a plurality of battery cells can be arranged in a curved shape so that a more aesthetic exterior can be realized and the entire device may be made compact through matching with the set device.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While the inventive technology has been described with reference to the figures, it will be understood by those of ordinary skill in the art that various changes in form and details may be made therein without departing from the spirit and scope as defined by the following claims.

What is claimed is:

1. A secondary battery comprising:
a plurality of battery cells;
a protective circuit module placed at a first side of the battery cells and configured to control a charging/discharging operation;
a connection tab electrically connecting the battery cells and the protective circuit module; and
an external terminal in electrical connection with the protective circuit module,
wherein the connection tab and the external terminal extend substantially parallel to each other along a longitudinal direction of the secondary battery and are placed at different levels in a first direction different from the longitudinal direction.

2. The secondary battery of claim 1, wherein the protective circuit module is placed in an upright position in the first direction so that front and rear surfaces thereof form a main surface.

3. The secondary battery of claim 1, wherein the connection tab and the external terminal are placed in a first surface of the protective circuit module, wherein the first surface faces the batteries.

4. The secondary battery of claim 1, wherein the height H1 of the battery cells defined in the first direction is less than the height H2 of the protective circuit module defined in the first direction satisfies (H1<H2).

5. The secondary battery of claim 1, wherein the length L1 of the battery cells defined in the longitudinal direction is greater than the length L2 of the protective circuit module defined in the longitudinal direction (L1>L2).

6. The secondary battery of claim 1, wherein the battery cells are arranged in a curved direction.

7. The secondary battery of claim 6, further comprising a cell holder into which the battery cells are inserted so as to connect the battery cells and to define an assembling position of the battery cells.

8. The secondary battery of claim 7, wherein the cell holder is formed of a composite material.

9. The secondary battery of claim 1, wherein the battery cells are arranged in a first row and a second row adjacent to each other.

10. The secondary battery of claim 9, wherein the battery cells in the first row and the battery cells in the second row are arranged in the same curved direction.

11. The secondary battery of claim 9, further comprising a plurality of connection members configured to electrically connect the battery cells to one another.

12. The secondary battery of claim 11, wherein the connection members comprise:
a first connection member configured to electrically connect the battery cells to each other in the same first row or in the same second row; and
a second connection member configured to electrically connect the battery cells in the first row to the battery cells in the second row.

13. The secondary battery of claim 12, wherein the second connection member connects the battery cells in the first row to the battery cells in the second row.

14. The secondary battery of claim 1, further comprising a case comprising a cell accommodation portion in which the battery cells are accommodated, and a circuit accommodation portion in which the protective circuit module is accommodated, and
wherein at least one terminal hole configured to expose the external terminal is formed in the circuit accommodation portion that protrudes upwardly from the cell accommodation portion.

15. The secondary battery of claim 14, wherein the case comprises first and second cases assembled in the first direction so that the first and second cases face each other,
wherein a step height caused by a difference in heights of the cell accommodation portion and the circuit accommodation portion is formed in the first case in an upward position, and
wherein the cell accommodation portion and the circuit accommodation portion are formed in the second case in a downward position and have substantially the same height.

16. The secondary battery of claim 14, wherein the terminal holes comprise first and second terminal holes respectively configured to expose first and second external terminals having opposite polarities, respectively, and
wherein an inversed insertion prevention portion configured to prevent inversed insertion caused by polarity confusion is formed in a vicinity of the first and second terminal holes.

17. The secondary battery of claim 16, wherein the inversed insertion prevention portion comprises a plurality of protrusions formed asymmetrically adjacent to the first and second terminal holes.

18. A secondary battery comprising:
a first cell holder configured to accommodate a first group of battery cells, wherein the first cell holder is curved to have a first curvature; and
a second cell holder adjacent to the first cell holder and configured to accommodate a second group of battery cells electrically connected to the first group of battery cells, wherein the second cell holder is curved to have a second curvature substantially the same as the first curvature, and wherein the first and second cell holders are arranged to accommodate the first and second groups of battery cells to be substantially aligned in a longitudinal direction thereof.

19. The secondary battery of claim 18, further comprising:
a protective circuit module placed at a side of the first or-second group of battery cells and configured to control a charging/discharging operation;
a connection tab electrically connecting the battery cells and the protective circuit module; and
an external terminal in electrical connection with the protective circuit module,
wherein the connection tab and the external terminal are placed on the same side of the protective circuit module.

20. The secondary battery of claim 18, wherein each of the first and second groups of battery cells are arranged in a curved direction.
